(19) United States
(12) Patent Application Publication
(10) Pub. No.: US 2008/0300960 A1
(43) Pub. Date: Dec. 4, 2008

(54) COMPETITIVE ADVANTAGE RATING METHOD AND APPARATUS

(75) Inventor: Gary A. Williams, Purcellville, VA (US)

Correspondence Address: LOWE HAUPTMAN HAM & BERNER, LLP, 1700 DIAGONAL ROAD, SUITE 300, ALEXANDRIA, VA, 22314, US

(73) Assignee: W RATINGS CORPORATION, Herndon, VA (US)

(21) Appl. No.: 11/756,440

(22) Filed: May 31, 2007

(51) Int. Cl. G06Q 10/00

(52) U.S. Cl. 705/10

(57) ABSTRACT

This invention relates to a rating method and apparatus that quantifies competitive advantage based on measurements of how well companies are delivering on consumer desires when benchmarked against their industry peers. More specifically, the method measures the existence of one or more barriers to entry, referred to herein as barriers, which companies build in order to protect their superior financial performance from competitors. The ratings further quantify the company's strength of their performance on the individual attributes that define each barrier. To begin analyzing competitive advantage in an industry, the Competitive Advantage rating method and apparatus starts by examining a company's past financial records. Using standard factor analysis, three sources of competitive advantage exist: Supply Chain, Products and Delivery Chain. Each source has three barriers for a total of 9 barriers common to every industry. While the sources of advantage have been around for centuries, since the dawn of business, this method identifies the drivers behind consumer desires and company delivery for each barrier.

### CROSS-REFERENCE TO RELATED APPLICATIONS

The present application is based on, and claims priority from, U.S. patent application Ser. No. 10/802,108, filed Mar. 17, 2004, the disclosure of which is hereby incorporated by reference herein in its entirety.

### FIELD OF THE INVENTION

This invention relates to a rating method and apparatus that quantifies competitive advantage based on measurements of how well companies are delivering on consumer desires when benchmarked against their industry peers. More specifically, the method measures the existence of one or more barriers to entry, referred to herein as barriers, which companies build in order to protect their superior financial performance from competitors. The ratings further quantify the company's strength of their performance on the individual attributes that define each barrier.

### BACKGROUND OF THE INVENTION

Durable competitive advantage is rare. Whenever a company is successful in attracting both customers and profits in an industry, competitors attempt to duplicate their approach which then drives financial returns toward the cost of capital. The ability to generate and sustain stronger financial returns than competitors substantially impacts the market value of a company.

Every business day, shares in thousands of companies are bought and sold based on investor perception of their worth. Buying a company is like buying a castle with a barrier around it, where that barrier protects a company's financial returns from competitive invasion. The strength of the barrier is directly related to its durability.

Because of regulatory requirements in the United States, the ability to view, compare and analyze corporate performance is readily available to any investor today. Stock and financial analysts spend enormous amounts of time examining the performance of these companies to better understand which ones are building a competitive advantage. Yet, virtually all analysts are limited to reviewing historical financials, published corporate/competitor statements, investigative reporting and personal knowledge. This provides for a highly subjective view of whether a company is building a competitive advantage.

To assess a company's future performance and strategy, financial analysts could try to rely on data from market research firms. No company can build superior financial performance before first selling and delivering products/services that meet customer desires. Corporations ultimately must generate revenue from customers, and since market researchers study how consumers buy and why the buy, answers to competitive advantage would seem to be readily available. Yet, the vast majority of market research focuses on the product/price and customer satisfaction of past purchases. This limits companies to examining how to improve what already exists, rather than trying to establish what the next set of customer needs are and how to meet them—something critical if a company is trying to build an advantage over its competitors.

When research about future needs is conducted, most of it is limited to focus groups, speculation and ultimately, educated guessing or intuitiveness. The researcher's goal is to find untapped markets to sell their products/services. Unfortunately, the output rarely, if ever, examines if and how the company can build a durable competitive advantage by meeting those needs. Instead, the focus remains on product/service features at an optimal price point. Success is often measured by gross profit margins, showing if a product/service can sell for a greater amount than its cost of goods sold (COGS). This limited financial perspective on success often results in less than satisfactory performance. In fact, most untapped markets—once identified by a leader—are quickly invaded by competitors that duplicate the leader's product/service features and match or undercut their prices.

Further complicating the ability to use market research to examine competitive advantage is its inherent need for uniqueness. Because of the extensive product/service differences between industries (e.g. mobile telephones don't taste like coffee, hotel rooms don't fly like an airplane), market research firms are unable to produce data for cross-industry comparison beyond the simple customer satisfaction survey. In fact, no method combines consumer desires, company delivery and dollars paid for a product/service in a standardized way, except as disclosed by Williams in US patent application Ser. No. 10-802108 (Demand 3-D method).

Thus, no method systematically connects how a company performs financially with how well they meet consumer desires when compared to their industry competitors. Without a common quantitative framework, no one is able to simultaneously benchmark a company's performance at the financial or consumer level. Stock analysts possess the financial records and knowledge, yet need conjecture to complete any type of assessment of competitive advantage. Market researchers possess consumer and product/price knowledge, yet lack the standardization, forward-looking quantitative metrics and financial perspective to measure competitive advantage.

What's required is a data-driven way to benchmark companies today—within or between industries—that integrates consumers' ratings of a company's ability to meet their desires with that company's ability to generate superior financial returns over a sustainable period of time.

The Competitive Advantage rating method and apparatus in this invention deliver on these requirements.

### DESCRIPTION OF THE PRIOR ART

In reviewing the prior art, three main categories exist including competitive strategy, financial analysis and customer satisfaction.

The most well-known analysis on competitive strategy is Michael Porter's five-forces framework to assess an industry's attractiveness. This work is most often cited in any type of corporate strategy effort. The five-forces are: 1) Supplier Power, 2) Buyer Power, 3) Substitution Threat, 4) Existing Rivalry, and 5) Barriers to Entry. Porter treats each of the five forces as relatively equal, yet the final one—barriers to entry—is the most critical to creating a durable competitive advantage. Companies that build one or more barriers to entry—referred to herein as barriers—can protect their economic returns and prevent any of the remaining forces from impacting them. As with other literature on competitive strategy and analysis, Porter identifies various sources of barrier to entry yet fails to make the direct connection to the integrated aspect of consumer needs and evaluation of functional, emotional and economic attributes. No framework or methods are offered to measure how a company meeting consumer desires builds superior profits.

Beyond competitive strategy and analysis, financial analysts perform competitive analysis on a company's financially virtually every day for the capital markets. In contrast to research performed on corporate strategy, investors seek to understand whether today's stock price of company is high or low in order to make a stock purchase decision. More specifically, investors want to know whether or not the expectations for a stock are already reflected in the stock price and therefore if future revisions will move up or down. Using readily available sources like CompuStat®, stock analytical methods such as O'Shaughnessy, et.al., U.S. Pat. No. 7,177,831, incorporate the key financial data as selection criteria for making stock purchases. This is a critical difference in purpose for the investment community, and subsequently drives the focus to be financial analysis versus strategic analysis. Financial analysts have limited access to consumer market data, except for what they assemble from third-party sources or outsource to another firm. This limits their ability to quantitatively connect financial with consumer market data.

One final category is the customer satisfaction industry. Since the advent of the first business, companies have been trying to understand how well they satisfy customers. The customer satisfaction industry involves the practice of surveying customers after they purchase a product/service to determine if they were satisfied or not. Intuitively, one knows that satisfying customers helps build a business. Yet, high customer satisfaction does not always translate into repeat purchases for a company and, more importantly, does not mean that a company is immune to competitive invasion. The primary purpose of customer satisfaction is to look at past performance, a process similar to drivers looking out their rear-view mirror, to see what companies should have done better. With no specific ability to track new and emerging consumer desires, the field of customer satisfaction is relegated to historical perspective.

Numerous organizations such as the American Customer Satisfaction Index (ACSI) attempt to connect customer satisfaction to economic returns. Their goal is quite different than understanding sources of competitiveness and predicting the strength of a company's ability to build durable advantage. Output of satisfaction studies may include data such as the cost of putting a caller on hold, delaying a product or losing a customer. Historical data is then analyzed to show linkage between satisfaction and shareholder value. This type of econometric analysis produces output for companies to identify critical areas of improvement, yet lacks the forward-looking ability to measure emerging consumer desires and which companies are best positioned to tap into them.

Consequently, the present invention overcomes the deficiencies, shortcomings and disadvantages by creating a Competitive Advantage rating method and apparatus that quantifies competitive advantage based on measurements of how well companies are delivering on consumer desires when benchmarked against their industry peers.

### REFERENCES CITED

U.S. PATENT DOCUMENTS

| | | |
|---|---|---|
| 6,658,391 B1 | 12/2003 | Williams, et al. |
| 10/802,108 | 03/2004 | Williams |
| 7,177,831 | 02/2007 | O'Shaughnessy, et al. |

### OTHER PUBLICATIONS

Cramer, James J., Jim Cramer's Real Money (New York: Simon & Schuster, 2005), page
Denove, Chris and Power I V, James D., Satisfaction: How Every Great Company Listens to the Voice of the Customer (New York: Portfolio, 2006), p. 2-5.
Dorsey, Pat, The Five Rules for Successful Stock Investing (New Jersey: John Wiley & Sons, 2004), page 25
Fornell, Claes G. “The Science of Satisfaction.” Harvard Business Review 79.3 (2001): 120-121)
Greenwald, Bruce and Kahn, Judd, Competition Demystified (New York: The Penguin Group, 2005), page 9
Piedmont, Ralph L., The Revised NEO Personality Inventory (New York: Plenum Press, 1998), p. 57-58.
Porter, Michael E., Competitive Strategy (New York: The Free Press, 1980, p 7-13.

### BRIEF SUMMARY OF THE INVENTION

Basic economic theory shows that in a highly competitive market, returns will be driven down to essentially “no economic profit” as rivals will attempt to imitate any advantage. As the universe of competitors continually changes or grows, the ability to build a competitive advantage that consistently translates into superior financial performance is significantly more difficult.

The Competitive Advantage rating method uses a common framework to measure the sources and strength of the competitive advantage of any company in any industry in a consistent way.

The logical starting point of any strategic analysis is to assess the industry to confirm the existence and sources of competitive advantage. Measuring or analyzing what's already happened is relatively straight-forward, although serious drawbacks exist to looking at only a company's income or sales when trying to compare two ore more company's performance. Industries differ in their asset levels and how they raise capital, so margin comparisons that cross boundaries are likely misleading. Thus comparing company performance within an industry (or across different industries) requires more than simply looking at revenue growth.

To begin analyzing competitive advantage in an industry, the Competitive Advantage rating method and apparatus starts by examining a company's past financial records. This analysis could take a variety of forms but most certain around two central themes: the amount of customers a company is attracting and the ability of the company to generate profits. A common way to analyze competitive advantage is to look at: 1) Stable or increasing market share within an industry, and 2) high ROIC (return on invested capital). ROIC is the adjusted operating earnings of a company divided by its total assets funded by debt or equity. Other financial metrics such as earnings per share (EPS), return on assets (ROA) or free cash flow could also be used.

For markets without competitive advantages, no company would have a superior financial return when compared to its competitors. Companies that do build an advantage are able to generate superior returns over long periods of time, such as five- or ten-years consecutively. Over time though, advantages often disappear as business markets evolve. So companies and their investors are constantly trying to identify the sources of competitive advantage, which companies have or are building them, and when they are losing their strength.

The most powerful way to build a durable advantage is to create a barrier to entry—or what Warren Buffet calls a barrier—which prevent competitors from taking away profits. Companies with barriers reward their investors with sustainable profit levels over time. Before a company can generate profits though, they must collect revenue from consumers. Thus, the precursor to any economic barrier is always a consumer barrier. Collectively, the two sides of a barrier create a barrier to entry that competitors are unable to penetrate on an economic and customer level.

This barrier approach first requires that a market exists for the company's product/service. The only way to proactively test for this existence is to identify and measure consumer desires and needs. To properly assess consumer desires, one must interview consumers about their functional, emotional and economic needs.

With functional needs, the Competitive Advantage rating method measures consumer desires across three business areas common to an industry, with four attributes

Products:

Quality, Uniqueness, Usefulness, Fair-Price

Management/Brand:

Security, Geography, Leadership, Culture

Operations/Sales/Service:

Competence, Responsiveness, Simplicity, Convenience

Specific wording for each attribute is amended to fit the industry and make sense to the consumer answering the questions. For example, interviews for the wireless industry possess questions such as Call Quality and Geographic Coverage whereas interview for the retail industry possess questions such as Store Quality and Geographic Locations. Regardless of the industry, the 12 concepts remain identical. Although three business areas are preferred and four attributes are preferred any number can be used which are consistent with the concept of the present invention.

Consumers don't make decisions based on utility alone though, so the Competitive Advantage rating method measures the intangible portion of consumer decision-making through five emotional needs:

Trust, precision, connection, variety and stability

These emotional needs are common to every human being in any culture, and are essentially derived from the five-factor model (FFM) of personality. Due to its deep psychometric roots, strategic profiling methods such as in U.S. Pat. No. 6,658,391 Williams et al., which is hereby incorporated by reference in its entirety into the present application, provide significant insights into how to use personality models to predict customer actions. Additionally, tools from The Revised NEO Personality Inventory provide for a rich analysis of normal personality (versus the voluminous literature on mental disorders) to properly assess behaviors.

These five emotional needs have direct relations to the functional attributes. For example, consumers that possess a high desire for product quality also need a high level of trust and precision from that company. These two high emotional needs are what drive the consumers to select a company's products with zero or near zero defects. The two are intertwined within the consumers mind, although they are not always easily voiced or understood by the consumer. The consumer's lack of ability to specifically state their needs is one reason the Competitive Advantage rating method and apparatus is so unique and powerful. The method provides the ability to accurately measure and combine the functional and emotional needs of consumers into a single desire rating.

The five emotional needs link to the twelve functional attributes in the following way.

QUALITY: Trust and Precision

UNIQUENESS: Trust, Precision, Connection and Variety

USEFULNESS: Trust, Connection and Stability

FAIR-PRICE: Trust, Precision and Stability

SECURITY: Precision, Variety and Stability

GEOGRAPHY: Trust, Precision and Variety

LEADERSHIP: Connection, Variety and Stability

CULTURE: Connection and Variety

COMPETENCE: Trust, Precision, Connection and Variety

RESPONSIVENESS: Precision and Connection

SIMPLICITY: Trust and Variety

TIME-SENSITIVITY: Precision, Connection and Variety

Again, although five emotional needs and twelve functional attributes are listed, any number can be used which are consistent with the concept of the present invention.

Using the above table, scores from emotional needs are easily combined into a single Emote score for each functional attribute. The two functional and emote scores provide a comprehensive view into how a consumer thinks (functional) and feels (emote). In other words, each score represents the tangible (functional) and intangible (emote) aspect of consumer decision-making.

Although the five emotional needs that are completely independent of one another, not all descriptions of emotions can be easily represented as one of five emotional needs. Facets are used to describe the greater range of emotions that exist. Facets are combinations of emotional needs that describe consumer traits such as Adaptive, Curiosity and Impulse. The Competitive Advantage rating method and apparatus use Facets to simplify the discussion of multiple emotional needs. Twelve Facets exist:

AMBITIOUS: Trust, Precision, Stability

SELF-ABSORPTION: Trust, Precision, Stability

EDUCATION: Precision, Variety, Stability

IMPULSIVE: Trust, Precision, Connection, Stability

REBELLIOUS: Trust, Precision, Connection

GRATIFYING: Trust, Connection

CURIOSITY: Connection, Variety

PLAYFUL: Trust, Connection, Variety

DATA & FACTS: Precision, Variety

INDULGENT: Precision, Stability

FEAR & UNCERTAINTY: Variety, Stability

ADAPTIVE: Connection, Stability

Again, although twelve facets are listed, any number can be used which are consistent with the concept of the present invention. The final aspect to understanding consumer desires is to measure their economic needs. Most research methods ask how much a person pays for a particular product/service, and some methods ask how much they are willing to pay. But this is virtually always asked in terms of an existing product/service or some futuristic description of it.

In addition to asking the price paid, the Competitive Advantage rating method and apparatus goes beyond traditional questioning and asks consumers how much more they are willing to pay if their desires were fully met. This provides a much needed forward-looking view into the potential strength of financial advantage a company could develop if they were to tap into these unmet needs. Consumers answer questions about their functional, emotional and economic desires within a specific industry.

In addition, the Competitive Advantage rating method and apparatus interviews customers on the same set of questions to measure how well a particular company is delivering against those desires. Identical sets of questions are asked about each competitor to the company as well. Once the scores are converted into norms tables, direct comparisons between all types of scores are possible. Specifically, these scores are:

DESIRES: Functional, 12 attributes
Emote, 12 attributes
Dollars
Emotional Needs, 5 needs
Facets, 12 facets

DELIVERY: Functional, 12 attributes
Emote, 12 attributes
Dollars
Emotional Needs, 5 needs
Facets, 12 facets

Using the scores for each company within an industry, the Competitive Advantage rating method and apparatus builds a comprehensive database to begin calculating the strength of each company's competitive advantage. This combines the above scores on consumer desires and company delivery with a company's financials for the same time period. Company scores for each attribute and financial metric (e.g. market share, ROIC) can then be assembled by percentile rank, and a threshold established that represents superior or high performance.

By looking at the data, the Competitive Advantage rating method can identify which consumer desires and company delivery relate directly to superior financial performance. Any patterns in the data show the sources of competitive advantage within that time period. Multiple years worth of data (e.g. five-years, ten-years) can identify the sources of durable advantage.

Using standard factor analysis, three sources of competitive advantage exist: Supply Chain, Products and Delivery Chain. Each source has three barriers for a total of 9 barriers common to every industry. FIG. 2 provides a complete look at the barriers and their representative companies. While the sources of advantage have been around for centuries, since the dawn of business, this method identifies the drivers behind consumer desires and company delivery for each barrier.

### Supply Chain Barriers:

1. Economies of Scale. A barrier built from the benefits of high volume in a focused area, rated through attributes Fair-Pricing, Geography and Time-Sensitivity. This advantage depends not on the ABSOLUTE size of the dominant company, but on the size DIFFERENCE between it and its rivals on market share. A developed barrier in scale means that the benefits of high volume have ultimately lowered the company's cost structure. Example: Over the past several decades, Wal-Mart Stores enjoyed a significant advantage based on its ability to spread its fixed costs over a large base of stores. These were operating expenses such as advertising or management costs. Spreading these fixed costs over an increasing amount of sales caused their average costs to decline. Other competitors such as Target and Costco or Home Depot and Lowes in the home improvement market have essentially grown to diminish Wal-Mart's scale benefits.

2. Economies of Skill. A barrier built from the benefits of core competencies, rated through attributes Fair-Pricing, Competence and Time-Sensitivity. This barrier depends on automating a customer process to benefit them in a time-sensitive way. Time-sensitivity does not necessarily mean faster, but that a company's timing is optimal for consumers (in other words, sometimes slow-paced is better.) Example: The original Federal Express automated the ability to move any standard package overnight to its destination—guaranteed by the next morning. The level of complexity required to accomplish this requires a finely tuned-system covering not just airplanes and trucks, but also technology, information and a skilled staff. Even at its premium price, Federal Express built an economies of skill advantage that took years for UPS and DHL to catch up.

3. Cost Containment. A barrier built from the benefits of comparative quality at fair-prices, rated through attributes Quality, Usefulness and Fair-Pricing. This barrier depends on building processes into the manufacturing or distribution process that gives the company a substantial cost differential. Example: By building sophisticated processes that govern suppliers and their custom-built process, Dell Inc. built a cost containment advantage over significantly larger and better financed behemoths such as Hewlett-Packard and IBM. Parts for Dell personal computers are often not purchased until a customer designs and orders one, and suppliers are typically located right next to a Dell manufacturing plant. No doubt that Dell borrowed several of the strategies originally implemented by Henry Ford for the automobile that controlled costs enough so the assembly-line workers producing them could afford to buy one.

Product Barriers:

4. Design Dominance. A barrier built from having a real functional and feature differences, rated through attributes Quality, Uniqueness and Leadership. This barrier is most difficult to maintain due to the ease of replication by competitors over time. Example: The original Apple personal computer and Apple's Macintosh computer are two of the most famous examples of Design Dominance. While each product was ousted as leader, their original features and capabilities provided Apple with a strong competitive advantage. The IBM® PC and Microsoft Windows® respectively were able to duplicate their basic feature set and each built different barriers that over-powered the superior Apple computer products.

5. Brand Perception. A barrier built from having a distinct, trusted brand, rated through attributes Uniqueness, Leadership and Culture. This barrier requires the most amount of time to attain, because the pathway to a trusted brand requires performance first, perception next. Companies with this barrier must weather the test of time to truly make it a durable advantage. Most critical is that Brand Perception is not the equivalent of differentiation. Many companies obtain a level of difference but that doesn't mean consumers actually desire it. The key is that the company must build trust through years of repeated, consistent performance unequal to its competitors. Example: Coca-Cola is one of the most enduring brands, having built a substantial reputation for its consistency and meaning. This largely emotional bond with consumers has not been replicated by Pepsi, although Pepsi has found sources of different advantage in which to compete.

6. Routine Reliance. A barrier built of having frequent usage based on consumer habit, rated through attributes Usefulness, Leadership and Impulse. This barrier depends on the habit-forming tendencies of consumers. Once a habit is formed, it will hold customers captive, typically on a daily (or high frequency) basis. Example: Without running a single advertisement, Starbucks has changed the way consumers drink, talk and experience coffee. No doubt exist that having a product that is a legal drug (caffeine) does enhance the reliance aspect of their barrier. Yet, Starbucks has made this into a near daily requirement for a significant portion of American consumers.

Delivery Chain Barriers:

7. Channel Lock-Out. A barrier built of a company's control in distribution for ease of consumer choice, rated through attributes Uniqueness, Security and Simplicity. This barrier is the most difficult yet the most durable: it is often due to government, financial or physical restrictions. Example: Target Stores has signed multiple manufacturers into exclusive relationships for apparel, kitchenware and other products. Most often, these relationships are with celebrity-like products that are easily used in advertisements to attract new and loyal customers. Because Target also offers other famous brands and private-label brands right next to the exclusive one, customers don't need to shop anywhere else. Going back to the 1800's, Samuel Brannan built a channel lock-out barrier for shovels and picks. Before he ran through the streets shouting that gold was coming from the American River, he bought every shovel in the San Francisco area.

8. Switching Lock-In. A barrier built from the consumer's fear the loss of time, money or status, rated through attributes Uniqueness, Usefulness and Responsiveness. This barrier depends on the captivity of customers due to the substantial time (training), money and effort (in general, fear) to replace one supplier with a new one. Example: Because PC software requires time to learn and money to buy, Microsoft Windows® built an advantage by getting consumers to invest in learning how to use their core Office applications and placing all of their data in it. Displacing this advantage requires not just an easy conversion of a consumer's files and documents, but also their ability to learn how to use the new toolset.

9. Network Effect. A barrier built from exponential growth with each node, rated through attributes Uniqueness, Culture and Time-Sensitivity. This barrier depends on building both ends of the supply and demand chains so that each additional node increases the value to the alternate side. Example: Through its auction-based website, eBay built a significant competitive advantage by bringing together a myriad of buyers and sellers of used merchandise. Every additional merchandise seller increases the value of eBay to buyers, and vice versa. In 1872, Montgomery Ward launched and eventually built a network effect advantage through the world's first mail-order business that connected buyers and sellers through a catalog.

The strength of the barrier determines the defensiveness of their competitive advantage. Companies with a durable advantage have built one or more of the nine barriers and continually out-delivered their industry peers to meet customer desires over long periods of time. But the goal of the Competitive Advantage rating method and apparatus is to identify which companies are developing the NEXT SET of advantages by looking for the presence or absence of a barrier. These emerging companies exceed the threshold on consumer desires and company delivery, yet do not exceed the threshold on financial metrics.

This unique approach combines economics, behavioral psychology and statistics to build a forward-looking system to identify the sources and strengths of competitive advantage.

The Competitive Advantage rating method, as illustrated in FIG. 1, comprises the following steps:

Step 1. Geographic Definition. Define the geographic location in which to measure the level of competitive advantage. While typically defined at the country level due to differences in legal and language, supersets of geographies (e.g. the world) and subsets of geographies (e.g. southeastern United States, California, Boston) are equally plausible. With the ability of customers to make purchases on the internet, geographic locations are best defined at the country level (e.g. United States, Australia, Germany, India).

Step 2. Business Market Definition. Define the business market in which to measure the level of competitive advantage. While most easily defined at an economic sector level (e.g. Consumer Goods, Industrial Goods, Utilities), a more practical and useful definition is at the industry level (e.g. Office Supplies, Lodging, Shipping).

Step 3. Company and Competitor Definition. Define the list of companies that compete in the business market for the geographic area. The list of companies does not need to be exhaustive in order to obtain accurate ratings. To ensure proper coverage, the list must include the most significant companies in terms of current sales in that market.

Step 4. Business Unit Definition. Define the business unit within each company that competes in the business market for the geographic area. Many companies structure themselves into divisions that compete on a business unit level. Each business unit produces different products/services and serves entirely different sets of customers.

Step 5. Financial Metrics Definition. Define the set of financial metrics that adequately define how well a company performs within the business market. Typically, core areas of financial performance include market share, return on invested capital (ROIC), revenue, earnings per share (EPS) from operations, free cash flow, return on assets (ROA), return on equity (ROE) and market capitalization.

Step 6. Functional Attribute Definition. Define the set of functional attributes that adequately represent how a company does business in this market. Typically, three areas are consistent across any type of business market: Products, Management/Brand and Operations/Sales/Service.

Step 7. Emotional Needs Definition. Define the set of emotional needs that adequately represent how a company does business in this market. Typically, five emotional needs are consistent across any type of business market: Trust, Precision, Connection, Variety and Stability.

Step 8. Pricing Power Definition. Define the set of pricing power attributes that adequately represent prices paid by customers to a business in this market. Typically, pricing power attributes consist of actual dollars paid by a customer, willingness to pay more if all functional attributes and emotional needs were met, payment method (e.g. Cash, Check, Credit Card), and payment frequency (e.g. Per Week, Per Month, Per Product, Per Visit).

Step 9. Customer Requirements Definition. Define the customer requirements that adequately represent the customers for each company within the Competitor Definition. Typically, customer requirements include having shopped, purchased or stopped making a purchase from a company in the market within a given time period (e.g. 30 days, six months, one year, five years).

Step 10. Assemble Interview Questionnaire. Combine the sets of functional attributes, emotional needs and pricing power into single questionnaire. Questions for functional attributes and emotional needs must be rated for both customer desires (e.g. how much product quality do you expect, what level of trust do you need) and the ability of a company to deliver.

Step 11. Pre-Qualify Customers. Locate, interview and select customers that meet the requirements criteria.

Step 12. Conduct Interviews. Using the pre-qualified list, interview a set of customers for each company as defined in the Competitor Definition.

Step 13. Ipsatize Functional Pre-Scores. Using the pre-scores of each functional attribute for each respondent, ipsatize each attribute's pre-score. To ipsatize, divide each functional attribute's pre-score by the average of all attributes for each respondent.

Step 14. Norms Tables. Create desires norms tables based on the pre-scores for each ipsatized functional attribute and emotional needs.

Step 15. Functional Scores. Using the desires norms table for each functional attribute, lookup the functional score using the ipsatized pre-score.

Step 16. Emotional Needs Scores. Using the desires norms table for each emotional need, lookup the emotional needs score.

Step 17. Emote Scores. Using the emotional scores, calculate the emote scores for each functional attribute. Emote scores are weighted contributions of multiple emotional needs scores that define the core emotional needs involved when evaluating that function.

Step 18. Facet Scores. Using the emotional needs scores, calculate the scores for facets. Facets are specific combinations of emotional needs scores that represent common decision-making traits found in customers (e.g. Impulsive, Curiosity, Playful, Adaptive).

Step 19. Consumer Desire Ratings. Using the functional and emote scores at the attribute level, calculate the desire rating for each attribute by averaging the functional and emote score.

Step 20. Company Delivery Ratings. Using the functional and emote scores at the attribute level, calculate the delivery rating for each attribute by averaging the functional and emote score.

Step 21. Win Ratings. Calculate the win rating of each company by dividing the sum of all delivery ratings by the sum of all desires ratings and multiplying by 100. The sums of ratings are typically equally weighted across all functional and emote ratings. Typically, the delivery ratings are adjusted downwards when a delivery rating exceeds desires by a large percentage.

Step 22. Performance Percentile Score. Using all of the company's desires and delivery ratings, calculate the percentile rank of each functional and emote attribute. The percentile rank used to establish grades of high performance may vary from the 50^{th} to 95^{th} percentile depending on each attribute.

Step 23. High Performance Threshold. Establish a threshold score to use when evaluating which companies are performing superior to competitors in this business market and geography. The typical high performance percentile is at the 65^{th} percentile.

Step 24. Barrier Scores. Calculate the scores for the competitive barriers of each company in this business market and geography. Barrier scores are specific combinations of desires and delivery ratings using both functional and emote scores.

Step 25. Company Barrier Rating. Calculate a company's desire & delivery rating for each barrier using a company's score for each barrier to evaluate if the score exceeds the high performance threshold. Those companies exceeding the threshold across all desires and delivery ratings for a barrier are building a competitive advantage.

Step 26. Financial Percentile Score. Using the core metrics used to define a company's financials, calculate the percentile rank of each company along each financial metric.

Step 27. Competitive Advantage. For companies that are building a competitive advantage, compare a company's financial percentile score to the high performance threshold. Those companies exceeding the thresholds have already built a competitive advantage (i.e. existing advantage), and those below the thresholds are in the process of building a competitive advantage (i.e. emerging advantage). Those companies with existing advantage over several measurement periods (e.g., five-years, ten-years) have built a durable competitive advantage.

Still other advantages of embodiments according to the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention.

### BRIEF DESCRIPTION OF THE FIGURES

The present invention is illustrated by way of example, and not by limitation, in the figures of the accompanying drawings, wherein elements having the same reference numeral designations represent like elements throughout and wherein:

FIG. 1 is a flowchart of the competitive advantage rating method according to one embodiment of the present invention;

FIG. 2 is a diagram of three business areas, each having three barriers and some examples;

FIGS. 3 and 4 are sample questionnaires;

FIG. 5 is a table showing an ipsatized set of scores;

FIG. 6 is a table showing an example of a 12-respondent data set and it corresponding percentile rank at each pre-score;

FIG. 7 is a flow chart detailing steps 13-18 in FIG. 1;

FIGS. 8 and 9 illustrates samples of the various ratings for Wal-mart and Target;

FIG. 10 illustrates a sample set of win ratings that do not contain weighing;

FIG. 11 illustrates a sample of percentile ranks for Wal-Mart and Target on the 12 functional delivery attributes;

FIG. 12 illustrates a sample of how Wal-Mart and Target compare in two different barriers, economies of scale and economies of skill.

FIG. 13 illustrates how to calculate a barrier rating from the percentile ranks in FIG. 12, assuming the high performance threshold is at the 65^{th} percentile.

FIG. 14 is a table showing the comparison of each company from 2001-2005; and

FIG. 15 is a diagram illustrating the competitive profiles of Wal-Mart and Target.

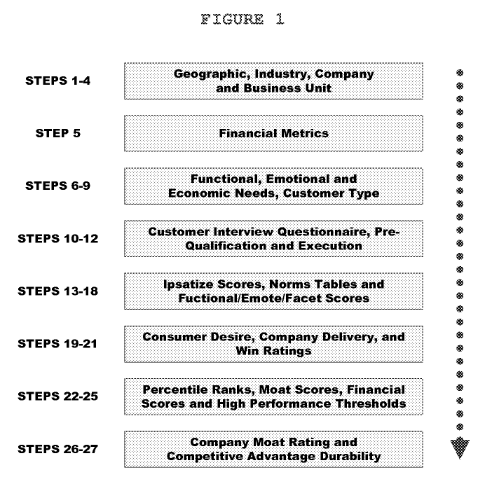

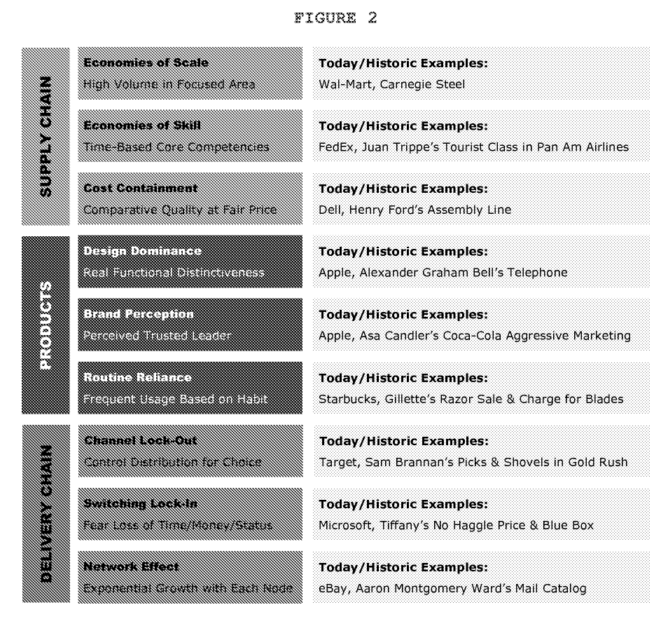

### DETAILED DESCRIPTION OF THE PREFERRED EMBODIMENT

The following example illustrates in detail how to use the Competitive Advantage rating method to determine the competitiveness of a company. This example compares the source of competitive advantage for Wal-Mart and Target, two of the largest retailers in the United States at this time. While on the surface, each company appears to compete head-to-head for consumer dollars, their true sources of competitive advantage are drastically different.

### Step 1. Geographic Definition

United States.

### Step 2. Business Market Definition

Retail Sector, Mass Discount Stores industry

### Step 3. Company & Competitor Definition

Big Lots, Costco, Dollar General, Dollar Tree, Family Dollar, Kmart, Sam's Club, ShopKo, Target, Wal-Mart

### Step 4. Business Unit Definition

Same as Step 3 since the companies listed here often report financials at the store level. For example, Wal-Mart owns Sam's Club but often breaks out their revenues in company filings. When a company does not break-out detailed financial metrics for a business unit, percentage contribution to each area can be estimated based on company management's guidance.

### Step 5. Financial Metrics Definition

For the Retail industry, the best metric to use to examine whether historical competitive advantage exists is Return On Invested Capital (ROIC). Many variations of ROIC formulas exist. A common one is:

ROIC=Net Operating Profit After Taxes (NOPAT)/Invested Capital

where:

Invested Capital=Total Assets−(Accounts Payable+Accrued Liabilities+Accrued Income Taxes)

### Step 6. Functional Attribute Definition

While concepts of the 12 functional attributes remain consistent across every industry, they must be modified so consumers understand what they are rating about a company and stating as their desires in that market. Pre-grouping of attributes helps to understand their completeness. For the retail industry, these are typically the following attributes:

### PRODUCTS—

QUALITY: Store Quality
UNIQUENESS: Uniqueness of Selection
USEFULNESS: Useful Loyalty Program
FAIR-PRICE: Fair-Pricing Practices

### MANAGEMENT—

SECURITY: Safety when Shopping
GEOGRAPHY: Geographic Locations
LEADERSHIP: Reputation as a Retail Leader
CULTURE: Company Culture

### SALES/SERVICES—

COMPETENCE: Competence of Staff
RESPONSIVENESS: Response to Customer Needs
SIMPLICITY: Simple Check-out and Returns
CONVENIENCE: Convenience while Shopping

### Step 7. Emotional Needs Definition

Some companies are better at emotional connections with consumers than others. Those companies are often said to have greater intangible value than their peers. Traditional research often fails to measure this type of connection. The optimum way to measure emotions is through a set of bipolar emotional needs. These needs are common to all humans, and therefore to all industries, sectors and geographies:
QUESTIONING vs. TRUST
FLEXIBLE vs. PRECISION
DETACHED vs. CONNECTION
ROUTINE-ORIENTED vs. VARIETY-ORIENTED
ANXIOUS vs. STABILITY

### Step 8. Pricing Power Definition

Most consumer research fails to incorporate the respondent's economic factors in decision-making, and in such a way to allow them to be directly compared to the desirability of a functional or emotional need. For the Retail industry, three questions are critical to understanding the power of pricing:
A. How much do you spend on an average visit to [insert store name, such as Wal-Mart or Target]? Possible answers are:
   0) Less than $5
   1) Less than $10
   2) Less than $15
   3) Less than $20
   4) Less than $30
   5) Less than $50
   6) Less than $100
   7) Less than $300
   8) $300 or more
   9) Not Sure
B. If this retailer were able to fully meet your desires, how much more would you be willing to pay?
   0) 0% (nothing more)
   1) 2-3% or more
   2) 5-7% or more
   3) 10-15% or more
   4) 15-20% or more
   5) 20-50% or more
   6) 50% or more
C. What method do you typically use to pay when at this retailer?
   0) Cash
   1) Check
   2) e-Check
   3) Debit: MasterCard
   4) Debit: Visa Card
   5) Debit: Discover
   6) American Express
   7) Discover Card
   8) MasterCard
   9) Visa
   10) PayPal
   11) OTHER
   12) Google Checkout
D. How often do you make purchases from this retailer?
   0) Everyday
   1) 2-3 Times a week
   2) Once a week
   3) 2-3 Times a month
   4) Once a month
   5) Every few months
   6) Rarely
   7) NONE

### Step 9. Customer Requirements Definition.

The length of time a customer has been using or purchasing from a company helps to understand its competitiveness. Companies with long-term customers tend to have more of a durable competitive advantage than others.
How long have you been a customer of this retailer?
   0) I have used them for more than 1 year
   1) I have used them for less than 1 year
   2) 1 no longer use them
   3) 1 have never used them
   4) 1 plan to start using them within the next 1 year for the first time

### Step 10. Assemble Interview Questionnaire

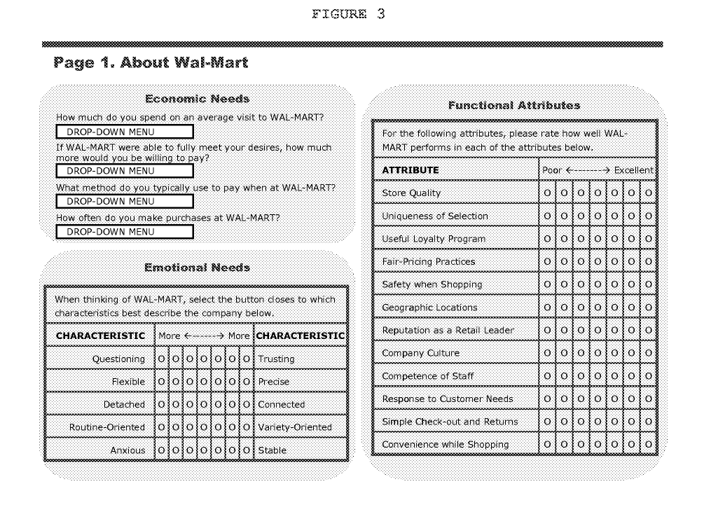

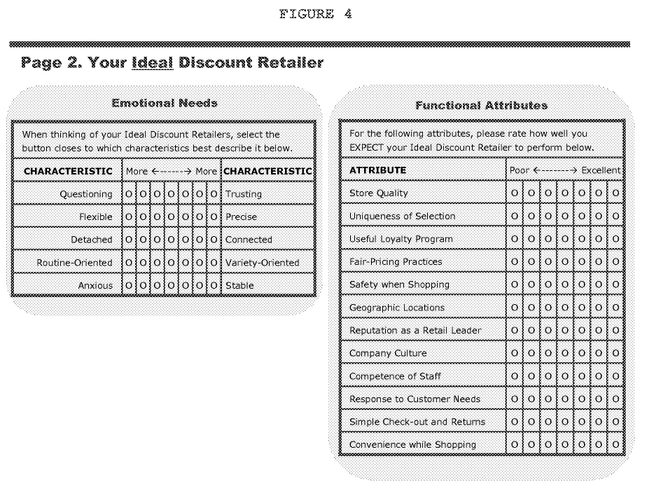

Combining all the questions into a short questionnaire is critical. To not introduce bias into the interviewing sample, the questionnaire should take less than 8 to 10 minutes to complete. See FIGS. 3 and 4 attached as an example of how to accomplish this.

### Step 11. Pre-Qualify Customers.

Every customer interviewed must be pre-qualified to ensure they have shopped and/or purchased from a company. A typical time period is whether the customer (or prospective or defected customer) has shopped or purchased at a retailer within the last six (6) months. For this survey, customers must have shopped or purchased at one of the following retailers: Big Lots, Costco, Dollar General, Dollar Tree, Family Dollar, Kmart, Sam's Club, ShopKo, Target, Wal-Mart.

### Step 12. Conduct Interviews

Interviews can be conducted via a number of means today such as telephone, mail, fax, in-person or online/web. The easiest way for most consumers to conduct an interview is online/web.

### Step 13. Ipsatize Functional Pre-Scores

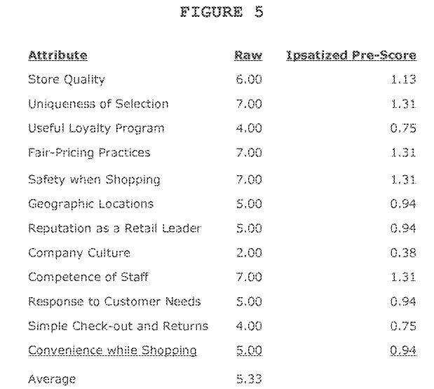

One considerable problem with analyzing consumer data is that one respondent's “excellent” rating is not the same as another respondent's “excellent”. For the first respondent, excellent might be a rating of 7 whereas the second respondent's is a rating of 5. To ensure ratings are equalized, the raw scores must be ipsatized. This process requires that the 12 attributes for desires be averaged, and then each attribute's raw score is divided by the average. FIG. 5 shows an example of an ipsatized set of scores:

### Step 14. Norms Tables Creation

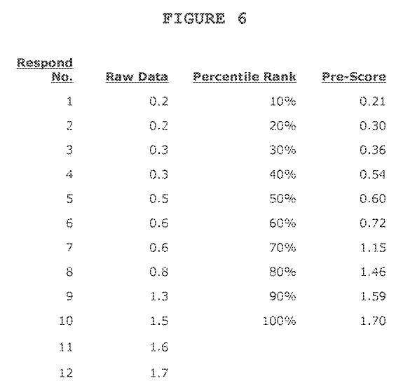

Over time, huge sets of scores are assembled using the identical rating system for a functional attribute or emotional need. These sets of data are then converted to derived scores, or norms, so they can be compared and interpreted with greater ease, clarity and statistical rigor. Several types of norms tables exist, one example being a percentile rank which identifies how many consumers rate a company below a particular score. An example of a 12-respondent data set and their corresponding percentile rank at each pre-score is in FIG. 6. Norms tables for functional attributes and emotional needs can be created in an identical manner. Norms tables like these can be significantly large, depending on the level of precision required when defining the number of decimal points. Because consumer desires represent the levels that companies are trying to deliver, norms tables need only be created for functional attribute desires and emotional needs desires. Delivery pre-scores utilize their corresponding Desires norms tables for consistency in measurement tools. For maximum accuracy, norms tables should be created for each geographic area due to the cultural differences within a society. The norms table can be created using data from random samples that are weighted to represent the nation's census population. These norms tables would become a “national desires index”.

### Step 15. Functional Scores

To determine a respondent's score for a functional attribute, lookup the ipsatized pre-score using the norms table for that attribute. Using the table in FIG. 6, an ipsatized pre-score of 0.59 would be at the 44.5 percentile. This means that 44.5% of respondents have rated this functional attribute 0.59 or lower. To make functional scores index so that 100 is the median desires, add 50 to the percentile rank score. The indexed functional score is now 94.5 (44.5+50), which is 6.5 points below the national desires index.

### Step 16. Emotional Needs Scores

To determine a respondent's score for an emotional need, lookup the raw score using the norms table for that characteristic. This is the identical process to Step 15.

### Step 17. Emote Scores

To evaluate how each respondent feels about a functional attribute, scores from multiple emotional needs are used to create an emote score. This provides a way to directly compare how consumers feel (i.e. emotional need) about a particular attribute against what they say (i.e. functional) about a particular attribute. For example, a consumer may say that fair-pricing is critical and a store's quality doesn't matter to them, so fair-pricing receives a high rating and store quality receives a low rating. When that same consumer must make a decision whether to shop at a discount price store or go to a department store, they feel better when shopping at a department store because the retailer provides a clean environment. Thus, the consumer's emotions trump their functional rating and they shop at a department store, provided the department store still fulfills their fair-pricing desires. In other words, store quality was critical for this consumer yet they were unwilling to admit it.

To generate the emote scores for each functional attribute, a common statistical procedure known as regression analysis helps to understand the relationship between emotional needs and each attribute. This analysis provides a way to measure the emotional part of decision-making of each functional attribute.

For example, Store Quality is a weighted combination of the two scores from Trust and Precision. For Fair-Pricing, the emote score is a weighted combination of Trust, Precision and Stability. The weighted combinations are derived from the regression analysis.

Emote scores are generated for each functional attribute, thus providing two sets of scores for each attribute. These provide both a functional and emote score on 12 attributes for a total of 24 scores. The scores are calculated in terms of consumer desires and how well a specific company is delivering against those desires, for a complete total of 48 scores. A gap analysis can be performed to determine how much better a company should be delivering to meet consumer desires in terms of functional or emote scores.

### Step 18. Facet Scores

The five emotional needs can be combined to generate measurements of tens of thousands of facets that guide decision-making. Facets are specific combinations of emotional needs scores that represent common decision-making traits found in customers. These traits provide greater details into what a consumer desires and how to best deliver to their specific needs.

Facets can then be used similar to a functional attribute when assessing how to meet consumer desires. For example, facets measure a consumer's desire to be impulsive as well as playful when going to a retail store. This would encourage a retailer to setup demonstration areas for consumers to try their products. The retailer might also have an option to immediately purchase the item that day by including free delivery, premium customer support, or add-on services. This approach would meet a consumer's desire for playful (i.e. try the product) and impulse (i.e. purchase now).

Each facet consists of a weighted combination of emotional needs scores. For example, Impulse is a weighted combination of Trust, Precision, Connection and Stability. Playful is a weighted combination of Trust, Connection and Variety. The weighted combinations are derived from psychometric scales and adjusted over time by correlating the weights with external behavior such as actual purchases made by a consumer.

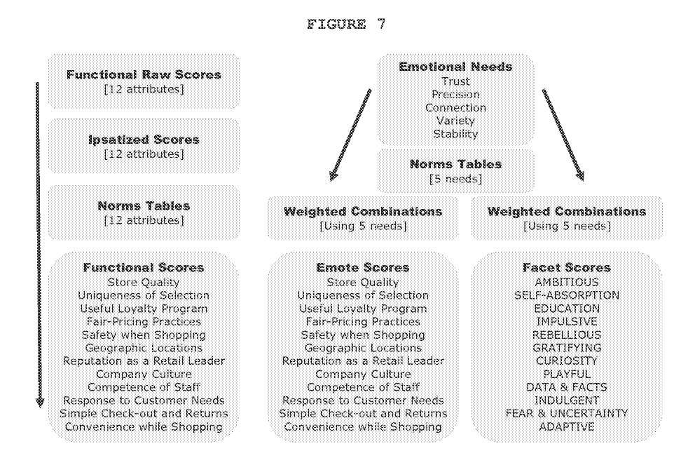

FIG. 7 captures the process used for steps 13 through 18.

### Step 19. Consumer Desire Ratings

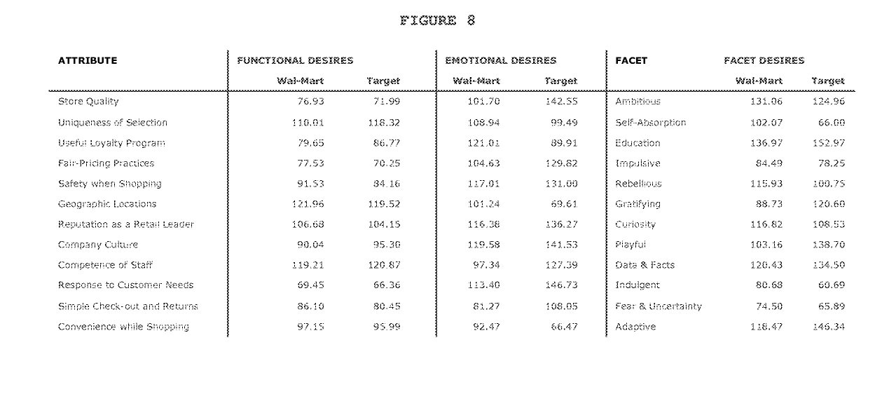

For companies to remain competitive, they must continue to meet consumer desires when compared to their peers. After collecting data on a valid set of consumers that statistically represent a company's customer set (current, prospective and/or defected), desires ratings across functional, emote and facet scores can be assembled. FIG. 8 illustrates a sample of the various ratings for Wal-Mart and Target.

### Step 20. Company Delivery Ratings

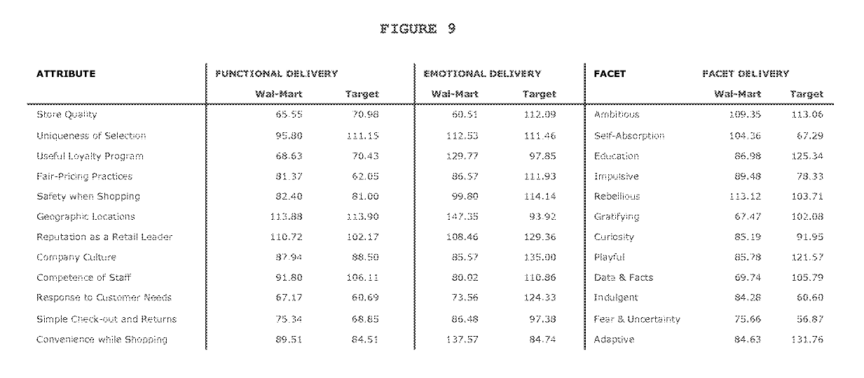

Similar to Step 19, ratings for how well companies deliver are assembled across the 12 attributes and 12 facets. FIG. 9 illustrates a sample of the various ratings for Wal-Mart and Target.

### Step 21. Win Ratings

A Win Rating, or W Rating for short, identifies in a single rating how well a company is winning the desires of customers. These are typically averages of each attribute's functional and emote score for both desires and delivery. The win rating of each company by dividing the sum of all delivery ratings by the sum of all desires ratings and multiplying by 100. The sums of ratings are typically equally weighted across all functional and emote ratings.

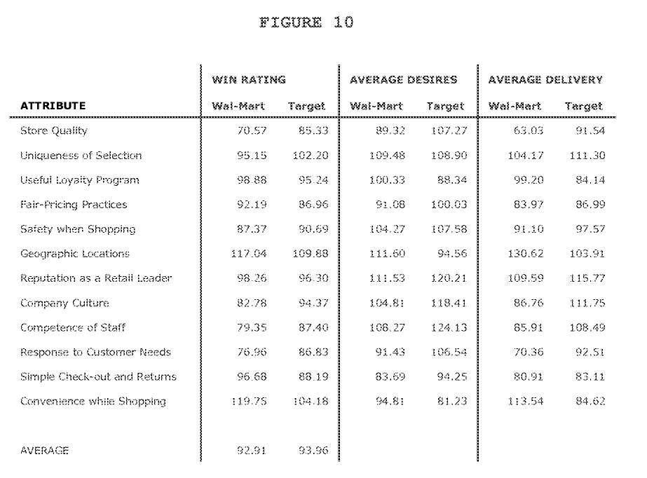

When an industry becomes more commoditized, desires and delivery ratings show a smaller gap as a whole. This may require that delivery ratings are adjusted downwards when a delivery rating exceeds desires by a large percentage. The ratings are then considered weighted based on industry results. FIG. 10 illustrates a sample set of Win Ratings that do not contain weighting.

### Step 22. Performance Percentile Score

To evaluate how well a company is performing when compared to its peers, each company's desire and delivery ratings for every attribute is placed into a percentile rank. This provides a simple way to benchmark one company against any other at the attribute level. The percentile rank shows the relative standing of the company within its data set of peers.

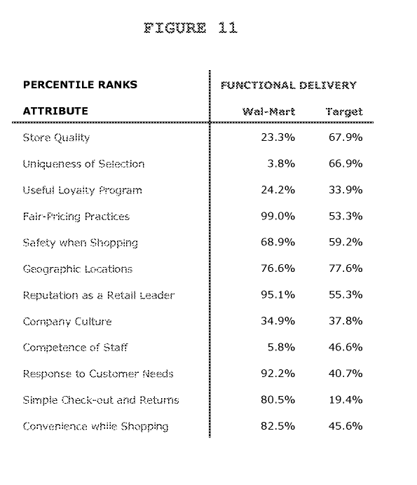

FIG. 11 illustrates a sample of percentile ranks for Wal-Mart and Target on the 12 functional delivery attributes. This sample shows that Wal-Mart's Fair-Pricing Practices is at the 99^{th} percentile level when compared to its retailing peers. Target is at about the 53^{rd} percentile level. This shows that Wal-Mart delivers better than virtually all of its retailing peers in terms of fair-pricing.

### Step 23. High Performance Threshold

Threshold scores are required to evaluate which companies are performing superior to their competitors in a business market and geography. The percentile rank used to establish grades of high performance may vary from the 50^{th} to 95^{th} percentile depending on each attribute. Establishing the threshold requires iterative analysis of performance of the major market companies within an industry. This establishes tiers of competitiveness that only the top companies are able to achieve. The typical high performance percentile is at the 65^{th} percentile.

### Step 24. Barrier Scores

Barriers are the specific characteristics of a company that competitors find enormously difficult to duplicate. Companies with barriers are able to perform at higher levels than their peers across core sets of attributes and facets. Performance is measured on both functional and emote score levels, as well as for both desires and delivery. Companies with superior performance on a barrier are best positioned to generate more profits than their peers.

Barrier scores are weighted combinations of the desires and delivery ratings across a specific group of attributes or facets.

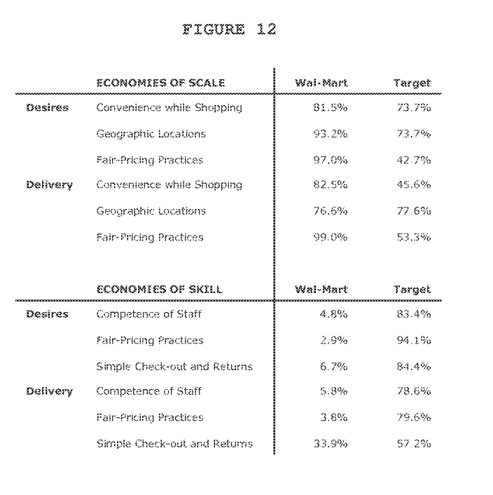

FIG. 12 illustrates a sample of how Wal-Mart and Target compare in two different barriers, Economies of Scale and Economies of Skill. Note that rankings for attributes such as Fair-Pricing Practices are not always identical due to the weighted contributions of functional, emote and facet scores within a particular barrier.

### Step 25. Company Barrier Rating

To determine whether a competitive advantage exists, each company receives a barrier rating that evaluates the strength of each barrier. The highest rating is a 5M, which means that a company has exceeded the high performance threshold across all attributes and facets for that barrier. Ratings are summarized into six percentile ranks, which means that certain companies can receive a negative rating of −1M.

The more barriers a company builds and the stronger those barriers are is directly related to a company's potential to generate superior profits over an extended period of time. A company must maintain their barriers and the strength of those barriers in order to succeed.

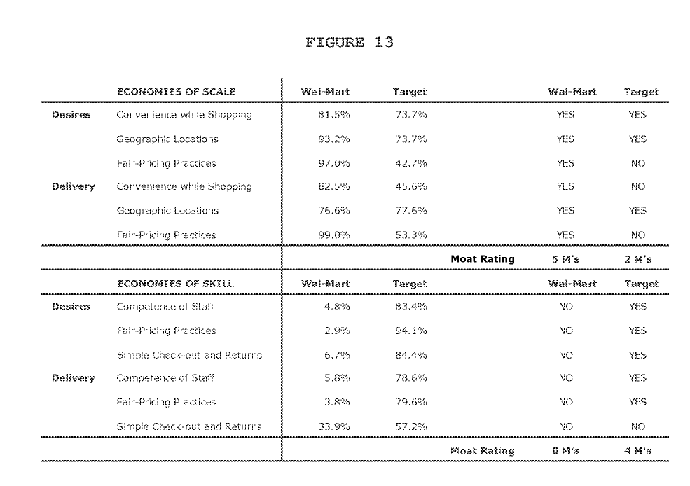

FIG. 13 illustrates how to calculate a barrier rating from the percentile ranks in FIG. 12, assuming the high performance threshold is at the 65^{th} percentile. In this example, Wal-Mart possesses a 5M rating for Economies of Scale, and Target possesses a 2M rating. When looking at Economies of Skill, Wal-Mart possesses a −1M rating and Target possesses a 4M rating. This example illustrates the differences in competitive approach for two large retailers that are trying to build market share.

### Step 26. Financial Percentile Score

For the retail sector, a strong financial measure of a company's competitiveness is its ability to generate superior Return-On-Invested-Capital (ROIC). Because both Wal-Mart and Target are public companies, these companies release detailed financial results that can be used to create a ROIC for each firm.

ROIC measurements are relative to the sector in which a company competes. Sometimes companies within a sector grow or contract together. Those companies with a durable competitive advantage should be able to out-grow and withstand any contraction when compared to their peers.

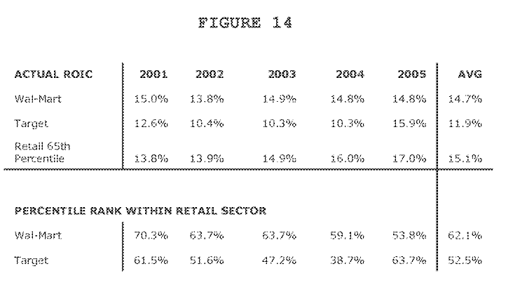

To examine a company's financial durability, a percentile rank for each firm's ROIC can be created over several years to compare within the sector. Wal-Mart and Target both compete in the retail sector, so direct comparisons of their ROIC are relevant. FIG. 14 shows the comparison of each company from 2001-2005. Wal-Mart's ROIC is on a steady decline whereas Target's ROIC was on the same decline but has just started to increase again in 2005.

### Step 27. Competitive Advantage

When determining the level of competitiveness, views of its past financial performance must be combined with views of its current benchmark performance with customers. Using a consistent high performance threshold at the 65^{th} percentile, a single view analysis can be performed by combining the nine barrier rankings with several years view of a company's ROIC.

This type of analysis provides greater depth into when a company may be building an emerging advantage. An emerging advantage exists when a company does not have a superior ROIC yet does have the existence of at least one or more of the nine barriers. Similar analysis can be performed to determine whether a company is sustaining its advantage. Companies with a strong barrier and superior ROIC over time has created a durable advantage. Companies with a declining ROIC and continuing strong barrier indicates that firm's advantage remains, yet management has likely been mismanaging its capital.

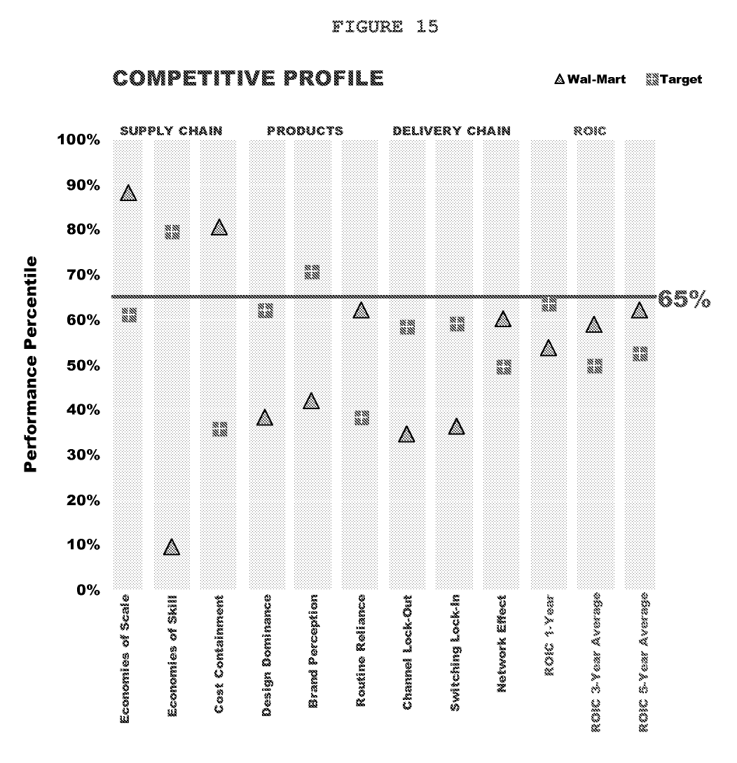

FIG. 15 illustrates the competitive profiles of Wal-Mart and Target. Wal-Mart's declining 5-Year ROIC yet continued current barrier in Economies of Scale shows that the company could be doing better financially. Target's profile shows they are beating Wal-Mart along a series of barriers and its 1-year ROIC shows an emerging competitiveness. While Wal-Mart could regain its competitive advantage, FIG. 15 shows the company no longer meets the criteria due to its lower ROIC ranking. The company's barriers in Economies of Scale and Cost Containment show that management should be generating a superior ROIC. With improved management, Wal-Mart could re-emerge with a competitive advantage especially since the Scale and Cost barriers are particularly durable over longer periods of time.

Target's performance indicates the company may be at the start of a competitive advantage period due to its two barriers in Economies of Skill and Brand Perception. While these barriers are difficult to maintain over long periods of time, Target could build or extend their advantages into Delivery Chain barriers. A rising 1-Year ROIC indicates the company's approach is working, and may very well be at the start of a competitive advantage period.

It will be readily seen by one of ordinary skill in the art that embodiments according to the present invention fulfill many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A rating method of quantifying competitive advantage based on measurements of how well companies are delivering on consumer desires when benchmarked against their industry peers, comprising:
analyzing a company's past financial records;
determining and measuring consumer desires across three business areas common to any industry;
determining and measuring consumer emotional needs;
linking the emotional needs to the consumer desires and calculating a score for each consumer desire;
determining consumer economic desires wherein the industry being measured;
conducting interviews with potential customers to determine their consumer desire, emotional and economic needs.

2. The method of claim 1, wherein the three business areas of consumer desire common to an industry are products, management/brand and operations/sales/service.

3. The method of claim 2 wherein the consumer desire for products has the following four functional attributes: quality, uniqueness, usefulness and fair price.

4. The method of claim 2, wherein the consumer desire for management/brand has the following four functional attributes: security, geography, leadership and culture.

5. The method of claim 2, wherein the consumer desire for operations/sales/service has the following four attributes: competence, responsiveness, simplicity and convenience.

6. The method of claim 1, wherein the emotional needs are trust, precision, connection, variety and stability.

7. The method of claim 3, wherein the emotional needs link to the functional attributes as follows:
QUALITY: Trust and Precision
UNIQUENESS: Trust, Precision, Connection and Variety
USEFULNESS: Trust, Connection and Stability
FAIR-PRICE: Trust, Precision and Stability
SECURITY: Precision, Variety and Stability
GEOGRAPHY: Trust, Precision and Variety
LEADERSHIP: Connection, Variety and Stability
CULTURE: Connection and Variety
COMPETENCE: Trust, Precision, Connection and Variety
RESPONSIVENESS: Precision and Connection
SIMPLICITY: Trust and Variety
TIME-SENSITIVITY: Precision, Connection and Variety

8. The method of claim 4, wherein the emotional needs link to the functional attributes as follows:
QUALITY: Trust and Precision
UNIQUENESS: Trust, Precision, Connection and Variety
USEFULNESS: Trust, Connection and Stability
FAIR-PRICE: Trust, Precision and Stability
SECURITY: Precision, Variety and Stability
GEOGRAPHY: Trust, Precision and Variety
LEADERSHIP: Connection, Variety and Stability
CULTURE: Connection and Variety
COMPETENCE: Trust, Precision, Connection and Variety
RESPONSIVENESS: Precision and Connection
SIMPLICITY: Trust and Variety
TIME-SENSITIVITY: Precision, Connection and Variety

9. The method of claim 5, wherein the emotional needs link to the functional attributes as follows:
QUALITY: Trust and Precision
UNIQUENESS: Trust, Precision, Connection and Variety
USEFULNESS: Trust, Connection and Stability
FAIR-PRICE: Trust, Precision and Stability
SECURITY: Precision, Variety and Stability
GEOGRAPHY: Trust, Precision and Variety
LEADERSHIP: Connection, Variety and Stability
CULTURE: Connection and Variety
COMPETENCE: Trust, Precision, Connection and Variety
RESPONSIVENESS: Precision and Connection
SIMPLICITY: Trust and Variety
TIME-SENSITIVITY: Precision, Connection and Variety

10. The method of claim 6, wherein the emotional needs link to the functional attributes as follows:
QUALITY: Trust and Precision
UNIQUENESS: Trust, Precision, Connection and Variety
USEFULNESS: Trust, Connection and Stability
FAIR-PRICE: Trust, Precision and Stability
SECURITY: Precision, Variety and Stability
GEOGRAPHY: Trust, Precision and Variety
LEADERSHIP: Connection, Variety and Stability
CULTURE: Connection and Variety
COMPETENCE: Trust, Precision, Connection and Variety
RESPONSIVENESS: Precision and Connection
SIMPLICITY: Trust and Variety
TIME-SENSITIVITY: Precision, Connection and Variety

11. The method of claim 7, wherein an emote score is calculated for each of the functional attributes.

12. The method of claim 6, wherein the emotional needs are further defined by facets, wherein the facets are:
AMBITIOUS: Trust, Precision, Stability
SELF-ABSORPTION: Trust, Precision, Stability
EDUCATION: Precision, Variety, Stability
IMPULSIVE: Trust, Precision, Connection, Stability
REBELLIOUS: Trust, Precision, Connection
GRATIFYING: Trust, Connection
CURIOSITY: Connection, Variety
PLAYFUL: Trust, Connection, Variety
DATA & FACTS: Precision, Variety
INDULGENT: Precision, Stability
FEAR & UNCERTAINTY: Variety, Stability
ADAPTIVE: Connection, Stability

13. A method of determining competitive advantage comprising the following steps:
defining a geographic location in which to measure the level of competitive advantage;
defining a business market in which to measure the level of competitive advantage;
defining a list of companies that compete in the business market for the geographic area;
defining a business unit within each company that competes in the business market for the geographic area; and
defining a set of financial metrics that adequately define how well a company performs within the business market.
defining a set of functional attributes that adequately represent how a company does business in this market;
defining a set of emotional needs that adequately represent how a company does business in this market;
defining a set of pricing power attributes that adequately represent prices paid by customers to a business in this market;
defining customer requirements that adequately represent the customers for each company within the competitor definition;
combining the sets of functional attributes, emotional needs and pricing power into single questionnaire;
locating, interviewing and selecting customers that meet the requirements criteria;
using the pre-qualified list, interview a set of customers for each company as defined in the competitor definition;
using the pre-scores of each functional attribute for each respondent, ipsatize each attribute's pre-score;
creating desires norms tables based on the pre-scores for each ipsatized functional attribute and emotional needs;
using the desires norms table for each functional attribute, lookup the functional score using the ipsatized pre-score;
using the emotional scores, calculate the emote scores for each functional attribute;
using the emotional needs scores, calculate the scores for facets;
using the functional and emote scores at the attribute level, calculate the desire rating for each attribute by averaging the functional and emote score;
using the functional and emote scores at the attribute level, calculate the delivery rating for each attribute by averaging the functional and emote score;
calculating the win rating of each company by dividing the sum of all delivery ratings by the sum of all desires ratings and multiplying by 100;
using all of the company's desires and delivery ratings, calculate the percentile rank of each functional and emote attribute;
establishing a threshold score to use when evaluating which companies are performing superior to competitors in this business market and geography;
calculating the barrier scores based on a company's desire and delivery ratings for the competitive barriers of each company in this business market and geography;
evaluating if the barrier score exceeds the high performance threshold;
using the core metrics used to define a company's financials, calculate the percentile rank of each company along each financial metric; and
determine if the company exceeds thresholds across all desire and delivery ratings in addition to financial metrics to build a competitive advantage.

14. The method of claim 13, wherein financial performance include market share, return on invested capital (ROIC), revenue, earnings per share (EPS) from operations, free cash flow, return on assets (ROA), return on equity (ROE) and market capitalization.

15. The method of claim 13, wherein three areas are consistent across any type of business market: products, management brand and operations/sales/service.

16. The method of claim 13, wherein five emotional needs are consistent across any type of business market: trust, precision, connection, variety and stability.

17. The method of claim 13, wherein typically, pricing power attributes consist of actual dollars paid by a customer, willingness to pay more if all functional attributes and emotional needs were met, payment method (e.g., cash, check, credit card), and payment frequency (e.g., per week, per month, per product, per visit).

18. The method of claim 13, wherein typically, customer requirements include having shopped, purchased or stopped making a purchase from a company in the market within a given time period (e.g., 30 days, six months, one year, five years).

19. The method of claim 13, wherein questions for functional attributes and emotional needs must be rated for both customer desires (e.g., how much product quality do you expect, what level of trust do you need) and the ability of a company to deliver.

20. The method of claim 13, wherein for ipsatized scores, divide each functional attribute's pre-score by the average of all attributes for each respondent.

21. The method of claim 13, wherein emote scores are weighted contributions of multiple emotional needs scores that define the core emotional needs involved when evaluating that function.

22. The method of claim 13, wherein an emote score is determined using regression analysis between emotional needs and each attribute.

23. The method of claim 13, wherein a facet is a weighted combination of emotional needs scores.

24. The method of claim 13 comprising determining a company's win rating.

25. The method of claim 13, comprising determining a company's barrier scores.

26. The method of claim 13, comprising determining a company's barrier rating.

27. The method of claim 13, wherein those companies exceeding the thresholds have already built a competitive advantage (i.e., existing advantage), and those below the thresholds are in the process of building a competitive advantage (i.e., emerging advantage), those companies with existing advantage over several measurement periods (e.g., five-years, ten years) have built a durable competitive advantage.
